(19) United States
(12) Patent Application Publication
(10) Pub. No.: US 2005/0024661 A1
(43) Pub. Date: Feb. 3, 2005

(54) Image processing apparatus, image processing method, and computer program

(75) Inventor: Masamichi Akashi, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/900,851

(22) Filed: Jul. 27, 2004

(30) Foreign Application Priority Data
Jul. 30, 2003 (JP) 2003-203746
May 24, 2004 (JP) 2004-153373

(51) Int. Cl. G06K 15/14; H04N 1/50; H04N 1/58

(52) U.S. Cl. 358/1.9; 358/504; 358/3.26; 399/44; 399/45; 399/58; 358/501

(57) ABSTRACT

An image processing apparatus includes a first determining unit for determining which medium an image is to be formed on; a second determining unit for determining an amount of a coloring material of a recording material according to the medium determined by the first determining unit; a color processing unit for executing color processing in a raster image processing unit according to the amount of the coloring material determined by the second determining unit; a comparing unit for comparing a predetermined medium with a medium that is to be used for output to determine whether these media match, after the color processing by the color processing unit; and a controlling unit for controlling whether to adjust the amount of the coloring material again according to a result of the comparison by the comparing unit.

### CROSS-REFERENCE TO RELATED APPLICATIONS

This application claims priority from Japanese Patent Application No. 2003-203746 filed Jul. 30, 2003, which is hereby incorporated by reference.

### BACKGROUND OF THE INVENTION

1. Field of the Invention

The present invention relates to an image processing apparatus, an image processing method, and a computer program for controlling the amount of a coloring material in a recording material in accordance with different media types.

2. Description of the Related Art

Techniques for adjusting the amount of toner application in accordance with different media types in an image processing unit of a color printer in which the maximum amount of toner application is restricted are known. Such techniques are disclosed, for example, in Japanese Patent Laid-Open No. 8-98048.

Usually, when a print job that has been stored in a large-capacity storage medium such as a hard disk in a printer is printed, the amount of toner application is predetermined.

In a printer, the optimum amount of toner is predetermined according to media type. If the amount of toner application is too large, inadequate transfer or inadequate fixing occurs. This causes toner spatter and degradation of image quality. Damage to the printer engine can also occur. On the other hand, if the amount of toner application is too small, an expected image quality cannot be achieved. Thus, the amount of toner application should be controlled optimally according to media types. Although the amount of toner application can be controlled by an image processor in a printer, the image processor is provided for adjusting the output density of an image, not for controlling the amount of toner application. Thus, excessive adjustment could be executed, causing degradation of image quality. Furthermore, referring to FIG. 9, a toner reduction unit controls the amount of toner application by determining whether the total amount of CMYK toner application exceeds a predetermined amount of toner application and reducing the amount of toner application to the predetermined amount for each color for which the predetermined amount is exceeded.

On the other hand, referring to FIG. 8, a CMS (color management system) unit in a RIP (raster image processing) unit controls the amount of toner application by using profiles to map from a display color space to a printer color space. The mapping between the color spaces is executed using optimum profiles in consideration of the maximum amount of toner application. Thus, the amount of toner application is controlled without degrading image quality.

When outputting an image after controlling the amount of toner application according to media types in a RIP unit, the amount of toner application for the assumed media type and the amount of toner application for actual output media type may not match.

When print data is already stored in a large-capacity hard disk, it is assumed that the media for storing print data in the hard disk and the media for outputting print data from the hard disk differ. Thus, conventionally, the default amount of toner application is generically set to a minimum amount for all media types. However, the amount of toner application may be insufficient depending on the type of media used for printing data from the hard disk. This reduces the density of the image and degrades the image quality.

### SUMMARY OF THE INVENTION

To address one or more of the aforementioned disadvantages and drawbacks, in one aspect, the present invention regulates the amount of coloring material for each media type in a raster image processing unit. In another aspect, the present invention can regulate the amount of the coloring material when a predetermined media type does not match a media type that is to be used for output, thereby protecting printer engines and providing improved image quality.

In a further aspect, the present invention suitably controls the amount of a coloring material of a recording material at the time of print processing after print data is once stored on a storage medium.

The present invention, in another aspect, provides an image processing apparatus including a first determining unit for determining which medium an image is to be formed on; a second determining unit for determining an amount of a coloring material of a recording material according to the medium determined by the first determining unit; a color processing unit for executing color processing in a raster image processing unit according to the amount of the coloring material determined by the second determining unit; a comparing unit for comparing a predetermined medium with a medium that is to be used for output to determine whether these media match, after the color processing by the color processing unit; and a controlling unit for controlling whether to adjust the amount of the coloring material again according to a result of the comparison by the comparing unit.

The present invention, in another aspect thereof, provides an image processing apparatus including a determining unit for determining an amount of a coloring material of a recording material according to an environmental condition detected; a color processing unit for executing color processing in a raster image processing unit according to the amount of the coloring material determined by the determining unit; a comparing unit for comparing a predetermined medium with the output medium to determine whether these media match, after the color processing by the color processing unit; and a controlling unit for controlling whether to adjust the amount of the coloring material again according to a result of the comparison by the comparing unit.

The present invention, in another aspect thereof, provides an image processing apparatus including determining unit for allowing a user to determine an amount of a coloring material of a recording material; a color processing unit for executing color processing in a raster image processing unit for a job that has been stored on a storage medium, according to the amount of the coloring material determined by the determining unit; a maintaining unit for maintaining an image rendered by the color processing unit and an amount of the coloring material used for rendering; a comparing unit for comparing the amount of the coloring material maintained by the maintaining unit with an amount of the coloring material for the output medium; and an adjusting unit for adjusting the amount of the coloring material maintained by the maintaining unit to the amount of the coloring material for the output medium when these amounts do not match.

The present invention, in another aspect thereof, provides an image processing method including a first determining step of determining which medium an image is to be formed on; a second determining step of determining an amount of a coloring material of a recording material according to the medium determined in the first determining step; a color processing step of executing color processing in a raster image processing unit according to the amount of the coloring material determined in the second determining step; a comparing step of comparing a predetermined medium with the output medium to determine whether these media match, after the color processing in the color processing step; and a controlling step of controlling whether to adjust the amount of the coloring material again according to a result of the comparison in the comparing step.

The present invention, in another aspect thereof, provides an image processing method including a determining step of determining an amount of a coloring material of a recording material according to an environmental condition detected; a color processing step of executing color processing in a raster image processing unit according to the amount of the coloring material determined in the determining step; a comparing step of comparing a predetermined medium with an output medium to determine whether these media match, after the color processing in the color processing step; and a controlling step of controlling whether to adjust the amount of the coloring material again according to a result of the comparison in the comparing step.

The present invention, in another aspect thereof, provides an image processing method including a determining step of allowing a user to determine an amount of a coloring material of a recording material; a color processing step of executing color processing in a raster image processing unit for a job that has been stored on a storage medium, according to the amount of the coloring material determined in the determining step; a maintaining step of maintaining an image rendered in the color processing step and an amount of the coloring material used for rendering; a comparing step of comparing the amount of the coloring material maintained in the maintaining step with an amount of the coloring material for an output medium; and an adjusting step of adjusting the amount of the coloring material maintained in the maintaining step to the amount of the coloring material for the output medium when these amounts do not match.

In another aspect of the present invention, an image processing method is disclosed. Initially, a first medium on which an image is to be formed is determined and then an amount of coloring material suitable for recording the image on the first medium is determined. In one aspect of the present invention, the amount of suitable coloring material is automatically determined. In another aspect, the amount of suitable coloring material is determined by a user. After that amount is determined, a raster image process is used to process the image based on the determined amount of coloring material. The image processing method then determines a second medium on which the image is actually output and compares the first and the second medium to determine whether these media match. If the first and second medium do not match, the amount of the coloring material on the second medium is adjusted.

Further features and advantages of the present invention will become apparent from the following description of the preferred embodiments with reference to the attached drawings.

### BRIEF DESCRIPTION OF THE DRAWINGS

The accompanying drawings, which are incorporated in and constitute a part of the specification, illustrate embodiments of the invention and, together with the description, serves to explain the principles of the invention.

FIG. 1 is a diagram showing an operation environment of a system according to an embodiment of the present invention.

FIGS. 2A and 2B are diagrams showing the overall configuration of a system controller according to an embodiment of the present invention.

FIG. 3 is a vertical sectional view of an image forming apparatus.

FIG. 4 is an operation flowchart from beginning a print job through determination of the amount of toner application to printing according to a first embodiment of the present invention.

FIG. 5 is an operation flowchart from beginning a print job to storage of a rendered image in an external storage device according to a second embodiment of the present invention.

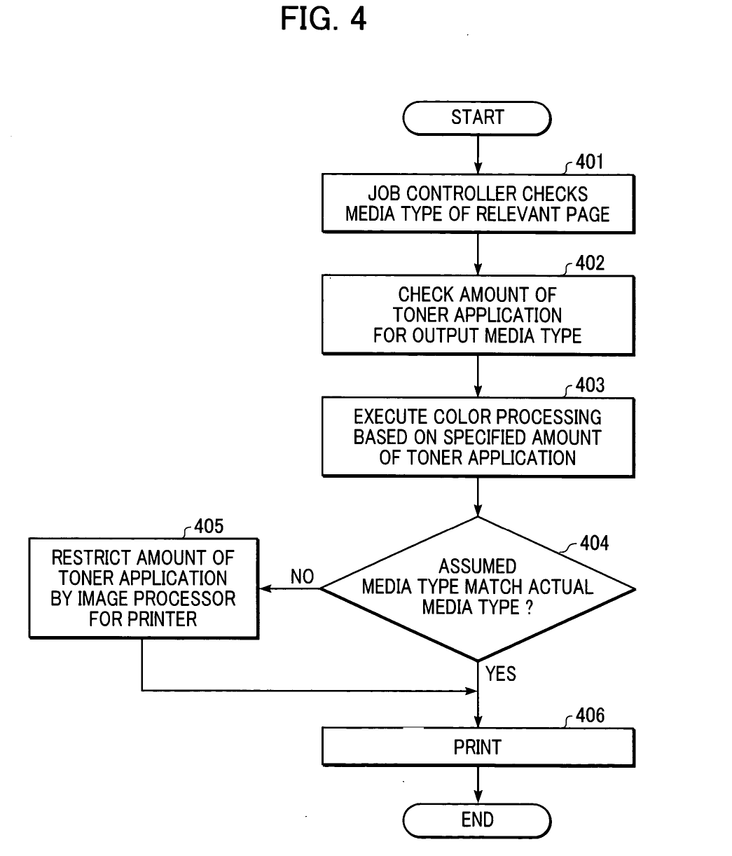

FIG. 6 is a flowchart of a procedure for determining the amount of toner application for printing an image stored in an external storage device and for printing the image according to the second embodiment.

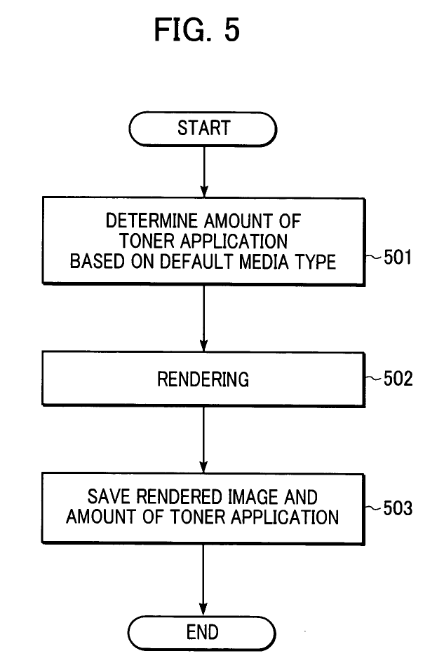

FIG. 7 is a diagram showing a RIP (Raster Image Processor) unit and an image processor according to an embodiment of the present invention.

FIG. 8 is a diagram schematically showing color space conversion in a CMS unit.

FIG. 9 is a diagram showing processing for restricting the amount of toner application in a TR (Toner Reduction) unit.

FIG. 10 is a diagram showing control of the amount of toner application for an image stored in an external storage device according to the second embodiment.

FIG. 11 is a diagram showing control of the amount of toner application using a DLC (Display List Control) unit according to a sixth embodiment of the present invention.

FIG. 12 is a diagram showing a configuration according to the sixth embodiment of the present invention.

### DETAILED DESCRIPTION OF THE INVENTION

First Embodiment

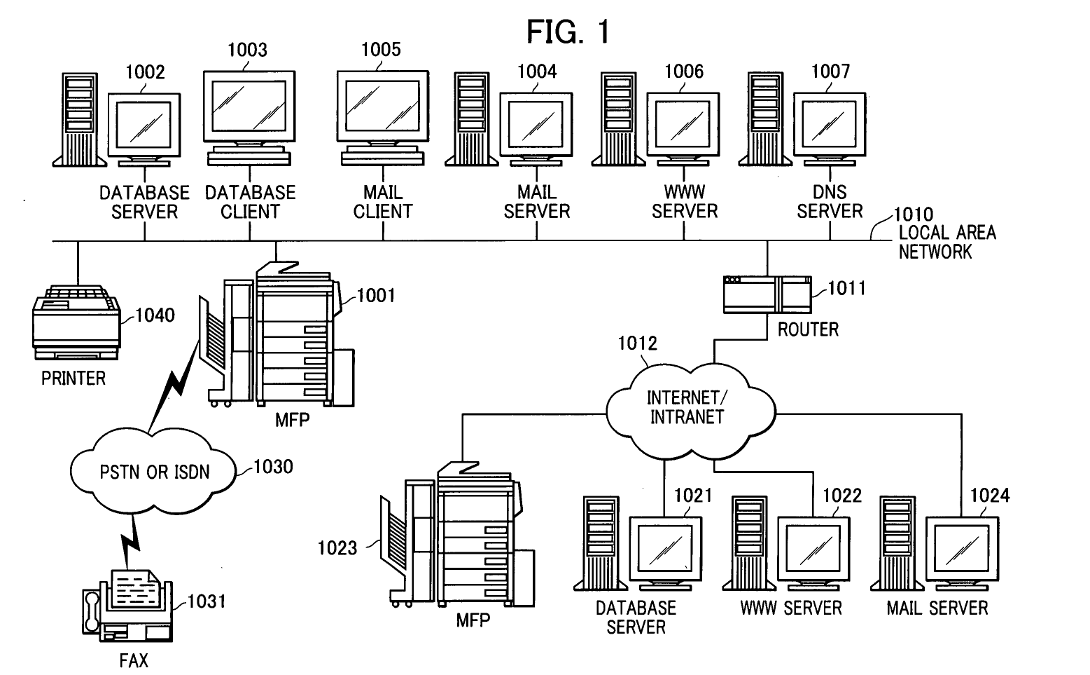

FIG. 1 shows the overall configuration of a network system according to a first embodiment of the present invention.

Referring to FIG. 1, a multi-function printer 1001 includes a scanner and a printer. The multi-function printer 1001 is capable of sending an image read by the scanner onto a local area network (LAN) 1010, and printing an image received via the LAN by the printer. Furthermore, the multi-function printer 1001 is capable of sending an image read by the scanner onto a PSTN (Public Switched Telephone Network) or ISDN (Integrated Services Digital Network) 1030 by a facsimile sending unit, and printing an image received via the PSTN or ISDN 1030. A database server 1002 manages a database of binary images and multi-valued images read by the multi-function printer 1001.

A database client 1003 associated with the database server 1002 is allowed to browse and search for image data stored in the database server 1002.

A mail server 1004 is capable of receiving an image read by the multi-function printer 1001 as an attachment to an electronic mail. A mail client 1005 is capable of receiving or browsing electronic mails received by the mail server 1004 and to send electronic mails.

A WWW (World Wide Web) server 1006 provides HTML documents to the LAN 1010, and the HTML documents provided by the WWW server 1006 can be printed by the multi-function printer 1001.

A router 1007 connects the LAN 1010 to the Internet or an intranet 1012. Furthermore, apparatuses 1020, 1021, 1022, and 1023 similar to the database server 1002, the WWW server 1006, the mail server 1004, and the multi-function printer 1001, respectively, are connected to the Internet or the intranet 1012. The multi-function printer 1001 is capable of exchanging data with a facsimile machine 1031 via the PSTN or ISDN 1030.

Furthermore, a printer 1040 is connected to the LAN 1010, so that an image read by the multi-function printer 1001 can be printed.

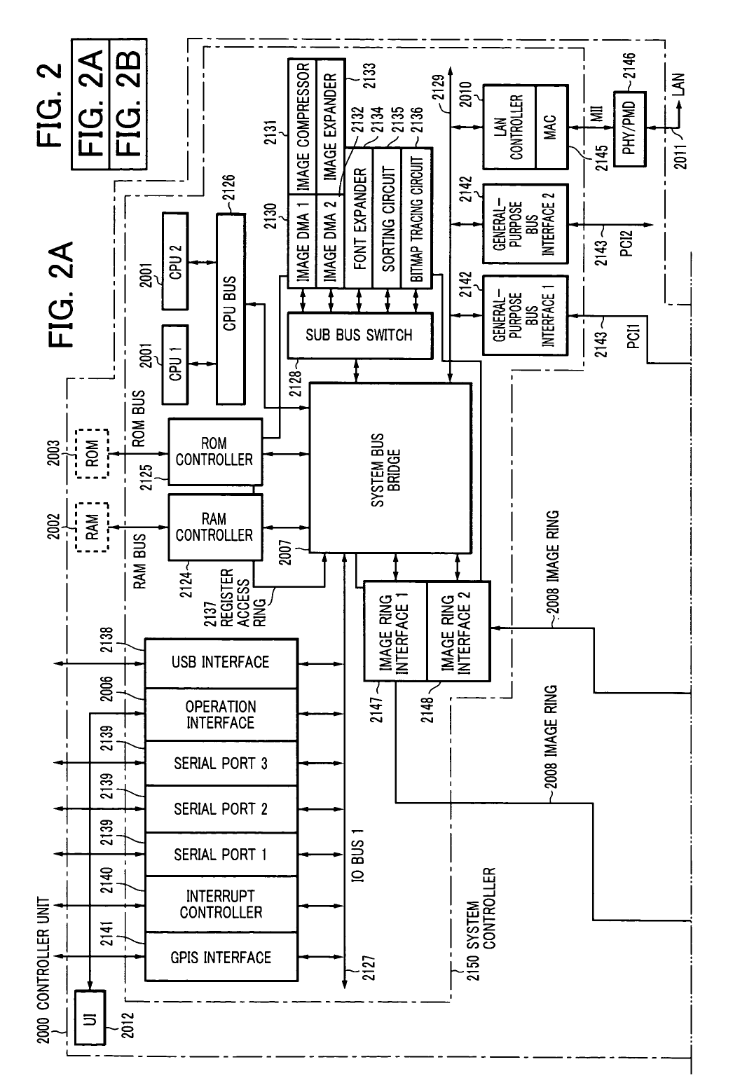

FIGS. 2A and 2B show block diagrams of the multi-function printer 1001.

Referring to FIG. 2, a controller unit 2000 is connected to a scanner 2070 that functions as an image input device and to a printer 2095 that functions as an image output device. The controller unit 2000 is also connected to a LAN 2011 or a public circuit (WAN) 2051, allowing input and output of image information and device information and rendering of PDL (page description language) data.

Central processing units (CPUs) 2001 controls the overall operation of the system. In this embodiment, two CPUs are used. The two CPUs 2001 are connected to a common CPU bus 2126, and are further connected to a system bus bridge 2007.

The system bus bridge 2007 is a bus switch, and is connected to the CPU bus 2126, a RAM controller 2124, a ROM controller 2125, a first IO bus 2127, a sub-bus switch 2128, a second IO bus 2129, a first image ring interface 2147, and a second image ring interface 2148.

The sub-bus switch 2128 is a second bus switch, and is connected to a first image DMA (direct memory access) controller 2130, a second image DMA controller 2132, a font expander 2134, a sorting circuit 2135, and a bitmap tracing unit 2136. The sub-bus switch 2128 arbitrates memory access requests output from the first and second image DMA controllers 2130 and 2132, and connects to the system bus bridge 2007.

A random access memory (RAM) 2002 is a system work memory for the operations of the CPUs 2001. The RAM 2002 is also used to temporarily store image data. The RAM 2002 is controlled by the RAM controller 2124. In this embodiment, the RAM 2002 is implemented by a direct RDRAM.

A read-only memory (ROM) 2003 is a boot ROM, and it stores a boot program for the system. The ROM 2003 is controlled by the ROM controller 2125.

The first image DMA controller 2130 is connected to an image compressor 2131. The first image DMA controller 2130 controls the image compressor 2131 based on information that is set via a register access ring 2137. Furthermore, the first image DMA controller 2130 reads and compresses uncompressed data on the RAM 2002, and writes the compressed data to the RAM 2002. In this embodiment, JPEG is used as a compressing algorithm.

The second image DMA controller 2132 is connected to an image expander 2133. The second image DMA controller 2132 controls the image expander 2133 based on information that is set via the register access ring 2137. The second image DMA controller 2132 reads and expands compressed data on the RAM 2002, and writes the expanded data to the RAM 2002. In this embodiment, JPEG is used as an expanding algorithm.

The font expander 2134 expands compressed font data stored in the ROM 2003 or the RAM 2002, based on font code included in PDL data transferred from outside via a LAN interface 2010.

The sorting circuit 2135 changes the order of objects in a display list generated during rendering of PDL data.

The bitmap tracing circuit 2136 extracts edge information from bitmap data.

The first IO bus 2127 is an internal input/output (IO) bus. The first IO bus 2127 is connected to a controller for a USB bus, which is a standard bus, a USB interface 2138, a general-purpose serial port 2139, an interrupt controller 2140, and a general-purpose input/output (GPIO) interface 2141. The first IO bus 2127 includes a bus arbiter (not shown).

An operating unit interface 2006 outputs image data to be displayed on a user interface (UI) 2012 to the operating unit 2012. Furthermore, the operating unit interface 2006 transfers information input by a user of the system via the operating unit 2012 to the CPUs 2001.

The second IO bus 2129 is an internal IO bus. The second IO bus 2129 is connected to first and second general-purpose bus interfaces 2142 and to the LAN controller 2010. The second IO bus includes a bus arbiter (not shown).

The general-purpose bus interfaces 2142 includes two bus interfaces of the same type. The general-purpose bus interfaces 2142 are a bus bridge that supports standard IO buses. In this embodiment, PCI (Peripheral Component Interconnect) buses 2143 are used.

A hard disk drive (HDD) 2004 is connected to one of the PCI buses 2143 via a disk controller 2144. The HDD 2004 stores system software and image data.

The LAN controller 2010 is connected to the LAN 2011 via a MAC circuit 2145 and a PHY/PMD circuit 2146, and it exchanges information with the LAN 2011.

A modem 2050 is connected to the public circuit 2051, and it exchanges information with the public circuit 2051.

A first image ring interface 2147 and a second image ring interface 2148 are DMA controllers that are connected to an image ring 2008 for rapidly transferring image data with the system bus bridge 2007, and that transfer compressed tile image data between the RAM 2002 and a tile image processor 2149.

The image ring 2008 is implemented by a pair of unilateral connecting paths (i.e., first and second image rings). The image ring 2008 is connected to tile expanders 2103, a command processor 2104, a status processor 2105, and tile compressors 2106 via a third image ring interface 2101 and a fourth image ring interface 2102 in a tile image processing unit 2149. In this embodiment, two tile expanders 2103 and three tile compressors 2106 are provided.

The tile expanders 2103 are connected to the third image ring interface 2101 and to a tile bus 2107. The tile expanders 2103 expand compressed image data input from the image ring 2008, and transfer the expanded image to the tile bus 2107. In this embodiment, JPEG is used as an expanding algorithm for multi-valued data, and PackBits is used as an expanding algorithm for binary data.

The tile compressor 2106 is connected to the image ring interface and to the tile bus 2007. The tile compressor 2106 compresses uncompressed image data input from the tile bus 2107, considering each set of a predetermined number of pixels (e.g., 8×8 pixels) as one tile, and transfers compressed image data to the image ring 2008. In this embodiment, JPEG is used as a compressing algorithm for multi-valued data, and PackBits is used as a compressing algorithm for binary data.

The command processor 2104 is connected to the third image ring interface 2101 and to a register setting bus 2109. When a register-setting request issued by one of the CPUs 2001 is input via the image ring 2008, the command processor 2104 writes the register-setting request to a relevant block connected to the register setting bus 2109. Furthermore, when a register-reading request issued by one of the CPUs 2001 is input, the command processor 2104 reads information from a relevant register via the register setting bus 2109, and transfers the information to the fourth image ring interface 2102.

The status processor 2105 monitors status of the image processors, generates an interrupt packet for issuing an interrupt to the CPUs 2001, and outputs the interrupt packet to the fourth image ring interface 2102.

The tile bus 2107 is connected to the blocks described above, and to a rendering unit interface 2110, an image input interface 2112, an image output interface 2113, a multiple-value converter 2119, a binarizer 2118, a color space converter 2117, an image rotator 2030, and a resolution converter 2116.

The rendering unit interface 2110 allows input of a bitmap image generated by a rendering unit that will be described later. The rendering unit and the rendering unit interface 2110 exchange ordinary video signals 2111 with each other. The rendering unit interface 2110 is connected to the tile bus 2107, a memory bus 2108, and the register setting bus 2109. The rendering unit interface 2110 converts a raster image into a tile image by a method specified via the register setting bus 2109 and performs clock synchronization, and outputs the tile image to the tile bus 2107.

The image input interface 2112 receives input of raster image data having been corrected by a scanner image processor 2114. The image input interface 2112 converts the raster image data into a tile image by a method specified via the register setting bus 2009 and performs clock synchronization, and outputs the tile image to the tile bus 2107.

The image output interface 2113 receives input of tile image data from the tile bus 2107, converts the tile image data into a raster image and changes the clock rate, and outputs the raster image to a printer image processor 2115 for correcting the densities of the respective color components (C, M, Y, and Bk).

The image rotator 2030 rotates image data while the resolution converter 2116 changes the resolution of an image. The color space converter 2117 converts the color space of color or grayscale images.

The binarizer 2118 binarizes a multi-valued (color or grayscale) image while the multiple-value converter converts a binary image into multi-valued data.

The external bus interface 2120 is a bus bridge that converts a write or read request issued by one of the CPUs 2001 and outputs the result to a third external bus 2121 via the first to fourth image ring interfaces, the command processor 2104, and the register setting bus 2009. In this embodiment, the third external bus 2121 is connected to the printer image processor 2115 and the scanner image processor 2114.

The memory controller 2122 is connected to the memory bus 2108. According to requests from the image processors, the memory controller 2122 writes, reads, or refreshes image data in the first and second image memories 2123 based on predetermined address divisions. In this embodiment, the image memories are implemented by SDRAMs.

The scanner image processor 2114 corrects image data scanned by the scanner 2070 that functions as an image input device. The printer image processor 2115 performs image correction for printing, and outputs the result to the printer 2095.

The rendering unit 2060 renders PDL code or intermediate display list into a bitmap image. Descriptions of components in FIG. 2 that are not directly related to the present invention are omitted.

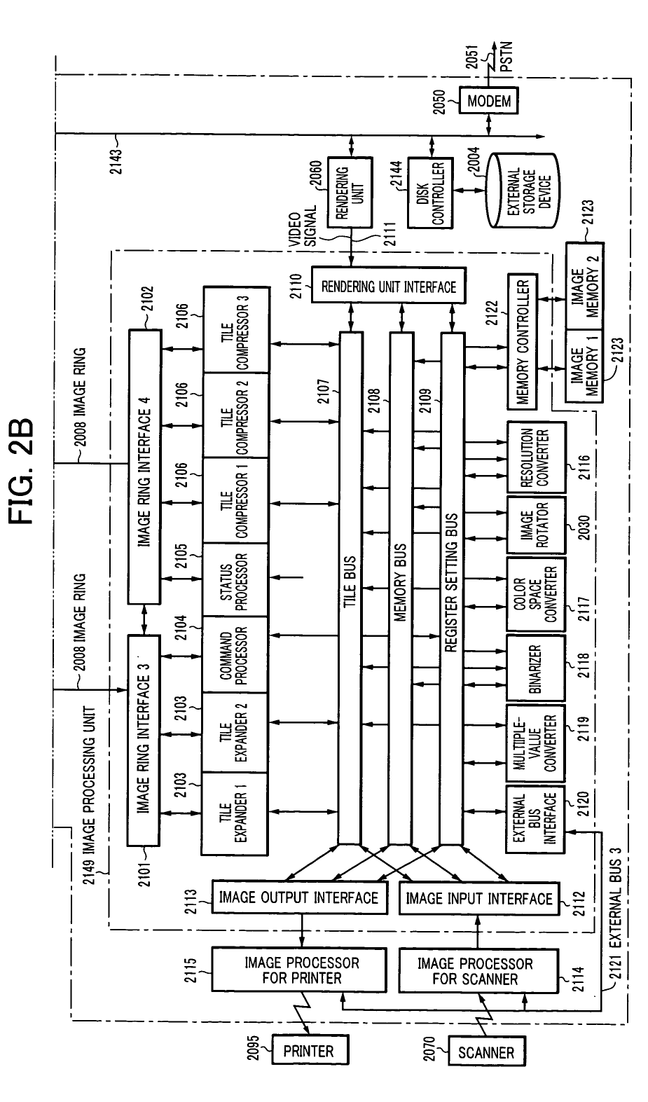

FIG. 3 is a schematic diagram showing the configuration of an image forming apparatus in the multi-function printer 1001. Referring to FIG. 3, the full-color image forming apparatus includes a digital color image reader unit (hereinafter simply referred to as a “reader unit”) R disposed in an upper part, and a digital color image printer unit (hereinafter simply referred to as a “printer unit”) P disposed in a lower part. In the image forming apparatus, based on an image of an original document 30 read by the reader unit R, the printer unit P forms a full-color image on a sheet S that serves as a recording medium, such as transfer paper.

The reader unit R and the printer unit P are now described as follows.

The reader unit R includes an original-document glass plate 31 on which an original document 30 is to be disposed and an exposure lamp 32 for exposing and scanning the original document 30 on the original-document glass plate 31. The reader unit R also includes a plurality of mirrors for reflecting a reflected optical image of the original document 30 exposed and scanned by the exposure lamp 32 and a lens 34 for condensing the reflected optical image, a full-color sensor (image reading device) 35 such as a charge coupled device (CCD) that accumulates the condensed reflected optical image. Other components of the reader unit R include a video processing unit 36 that functions as a controller, and a storage device 37. In the reader unit R, the reflected optical image is condensed at the full-color sensor 35 to obtain color component signals, and the density of a reference image is read by the full-color sensor 35. The color component signals are amplified by an amplifier circuit not shown, and the amplified signals are processed in the video processing unit 36, and the resulting signals are transferred to the printer unit P.

In the printer unit P, a drum-shaped electrophotographic photosensitive member (hereinafter simply referred to as a “photosensitive drum”) 1 that functions as an image carrier has a diameter of 180 mm. The photosensitive drum 1 is supported by a shaft so as to allow rotation in the direction of an arrow R1 in FIG. 3. In the periphery of the photosensitive drum 1, a pre-exposure lamp 7 for initializing the surface of the photosensitive drum 1, a corona charger 2 for uniformly charging the surface of the photosensitive drum 1, an image exposing device 3 for forming an electrostatic latent image on the photosensitive drum 1 based on image information, a potential sensor 12 for detecting a surface potential of the photosensitive drum 1, a developing unit containing toners of different colors for developing the electrostatic latent image formed on the photosensitive drum 1 into a visible image (toner image), an optical detector 13 for detecting the amount of toner on the photosensitive drum 1, a transferring unit 5, and a cleaner 6 for removing toner remaining on the photosensitive drum 1. These components are disposed in order along the direction of rotation of the photosensitive drum 1.

The image exposing device 3 includes a polygon mirror 3a, a lens 3b, and a mirror 3c. In the image exposing device 3, laser beam (optical image) from a laser outputting unit (not shown), modulated according to color component image signals from the reader unit R, is reflected by the polygon mirror 3a, and the reflected light is projected onto the surface of the photosensitive drum 1 via the lens 3b and the mirror 3c. An electrostatic latent image corresponding to the color component image signals is then formed.

The developing unit 4 includes four developers 4C, 4M, 4Y, and 4K. In accordance with the colors of the electrostatic latent image, eccentric cams 24C, 24M, 24Y, and 24K operate so that the developers 4C, 4M, 4Y, and 4K will be drawn near to the photosensitive drum 1.

When forming an image in the printer unit P, the photosensitive drum 1 is rotated in the direction of the arrow R1 in FIG. 3 at a rate of 200 mm/sec. First, the pre-exposure lamp 7 discharges the surface of the photosensitive drum 1 for initialization. Then, the corona charger 2 uniformly charges the surface of the photosensitive drum 1, and the image exposing device 3 irradiates the surface of the photosensitive drum 1 with laser beam E corresponding to color component image signals so that an electrostatic latent image corresponding to the color component image signals is formed in a predetermined order of colors.

Then, the developers 4C, 4M, 4Y, and 4K operate in a predetermined developing order of cyan (C), magenta (M), yellow (Y), and black (K) to develop the electrostatic latent image on the photosensitive drum 1, so that resin-based toner images are sequentially formed on the photosensitive drum 1. The developers 4C, 4M, 4Y, and 4K of the developing unit 4 are selectively drawn near to the photosensitive drum 1 in accordance with the colors of toner images by the operations of the eccentric cams 24C, 24M, 24Y, and 24K.

A sheet S that is fed from a sheet cassette 7a, 7b, or 7c (or manually fed) by a transferring system including a pickup roller, a feeding guide, and a feeding roller, is wound on the transferring unit 5 in synchronization with the timing when the toner image formed on the photosensitive drum 1 is transferred to a predetermined position.

The transferring unit 5 includes a transferring drum 5a having a diameter of 180 mm, which functions as a sheet carrier, a transferring charger 5b for transferring a toner image on the photosensitive drum 1 onto the sheet S, a drawing corona charger 5c for drawing the sheet S to the transferring drum 5a, a drawing roller 5g that functions as an opposite pole, an inner corona charger 5d, an outer corona charger 5e, and a separating charger 5h. In the periphery of the transferring drum 5a that is rotatably supported by a shaft, a sheet carrying sheet 5f having a cylindrical shape, composed of a dielectric material, is provided.

In the transferring unit 5, it is possible to carry two sheets S of A4 size, or one sheet S of A3 size. Images can be formed on the sheets S by emitting light corresponding to the same image continuously, forming a toner image on the photosensitive drum 1 continuously, and transferring the toner image. The sheet carrying sheet 5f is a dielectric sheet composed of a polycarbonate film.

The transferring drum 5a is rotated in synchronization with the photosensitive drum 1 in the direction of the arrow R5 in FIG. 3. A cyan toner image developed by the cyan developer 4C is transferred onto a sheet S carried by the sheet carrying sheet 5f by the transferring charger 5b at a transferring section (at a contact between the photosensitive drum 1 and the transferring drum 5a). The transferring drum 5a keeps rotating, and prepares for transfer of a toner image of the next color (e.g., magenta).

The cleaner 6 removes residual toner or the like on the photosensitive drum 1 carrying a toner image transferred thereto. Then, the photosensitive drum 1 is uniformly charged by the corona charger 2 again, and receives image exposure by laser beam E modulated by a next magenta image signal. The magenta latent image is developed by the magenta developer 4M, whereby a magenta toner image is formed. The magenta toner image is transferred onto the sheet S carried by the sheet carrying sheet 5f by the transferring charger 5b at the transferring section, whereby the magenta toner image is transferred so as to overlap the cyan toner image. The transferring drum 5a keeps rotating, and prepares for transfer of a toner image of the next color (e.g., yellow).

The process described above is repeated to form and transfer yellow and black images. When overlapped transferring of toner images of the four colors is finished, the sheet S is discharged by the separating charger 5h that causes an AC corona discharge, and is then separated from the transferring drum 5a by the operation of a separating pushup corona 8b and a separating tooth 8a, is transferred to a thermal roller fixer 9, where the toner images are fixed, and the sheet S is ejected onto a tray 10.

In order to prevent spattering or attachment of powder such as toner on the sheet carrying sheet 5f of the transferring drum 5a, or attachment of oil on the sheet S, cleaning is performed by the operations of a fur brush 14, a backup brush 15 opposing the fur brush 14 via the sheet carrying sheet 5f, an oil removing roller 16, and a backup brush 15 opposing the oil removing roller 16 via the sheet carrying sheet 5f. The cleaning is performed before or after forming an image. The cleaning is also performed when a paper jam occurs.

Descriptions of components in FIG. 3 that are not directly related to description of the present invention are omitted.

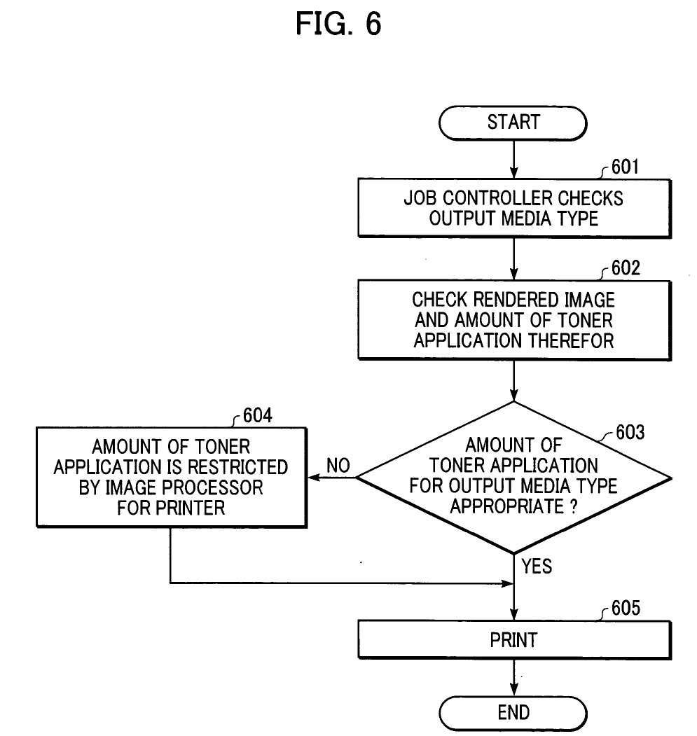

FIG. 7 is a block diagram showing the construction of a raster image processing (RIP) unit. Generally, RIP refers to rendering data written in a PDL into bitmap data that can be printed or displayed. Referring to FIG. 7, the RIP unit includes an interpreter unit for interpreting PDL data and converting it into a display list that serves as an intermediate data format. The RIP unit also includes a color management system (CMS) unit responsible for color management, a toner reduction (TR) unit for regulating CMYK signal values sent to a printer engine in order to protect the printer engine, and a renderer unit for rendering the display list into bitmap data. In this embodiment, the interpreter unit includes a soft TR unit, and the renderer unit includes a hard TR unit.

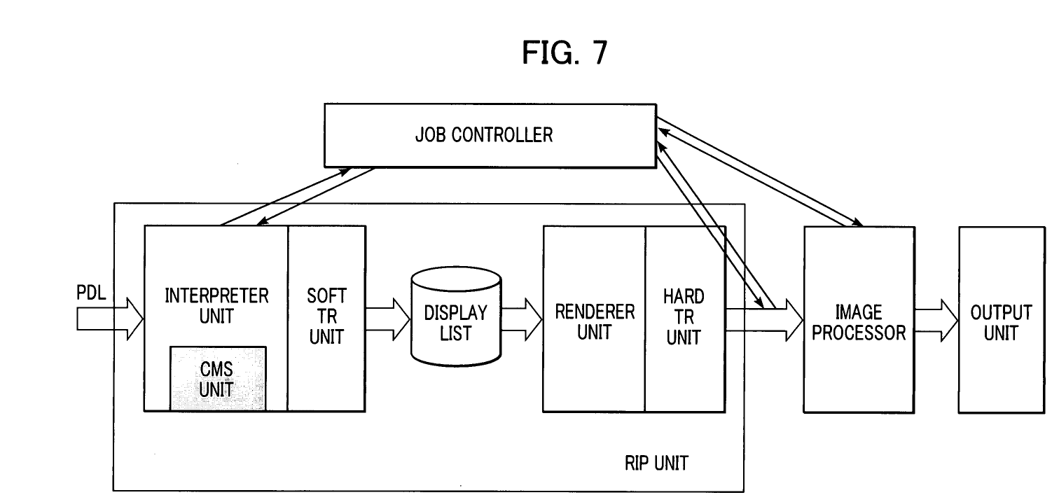

FIG. 8 schematically shows conversion between color spaces by the CMS unit in the RIP unit. For the purpose of mapping colors represented in a display color space into colors represented in a printer color space, two profiles, i.e. an input profile and an output profile, such as ICC profiles, are specified so that colors viewed on the display will match colors of print data output from the printer. The output profile is optimized for each printer, and in optimizing the output profile, a plurality of profiles is created in consideration of the maximum amount of toner application.

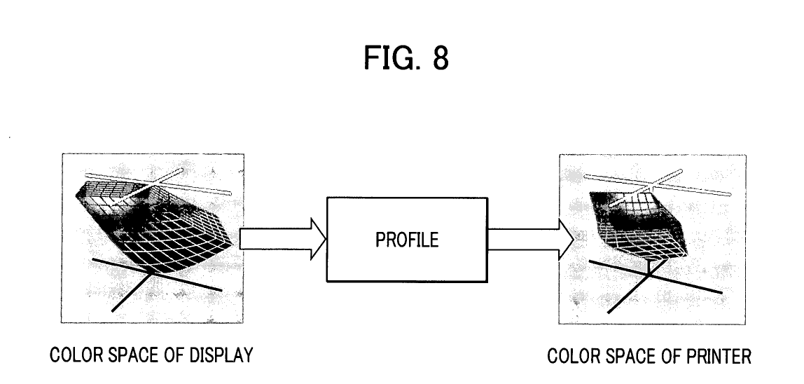

FIG. 9 shows the regulation of the amount of toner application by the TR units. When various graphic objects are input, color values are checked, and the total amount of toner application of a fully processed image including CMYK is calculated. It is checked whether the total amount of toner application exceeds a threshold value of the amount of toner application. If so, the amount of toner application is reduced to the threshold value of the amount of toner application. The soft TR unit and the hard TR unit are substantially similar in terms of algorithms used. However, the hard TR unit permits image formation with a single amount of toner application over the entire image. On the other hand, the soft TR unit executes toner reduction by software processing using a program. The soft TR unit allows the toner reduction process to be changed depending on types of image objects. Other advantages comprise use of the soft TR unit as an alternate to the hard TR unit, as well as for implementing a new function not provided in hardware design.

In this embodiment, the user turns on CMS processing, the CMS unit controls the amount of toner application so that the amount of toner application will be optimal for a predetermined media type, and the amount of toner application is not changed. However, when PDL processing in the RIP unit is finished and bitmap data is actually output to the printer unit, if the actual media type used for output differs from the predetermined media type, for example, due to the absence of sheets or a paper jam, the amount of toner application must be controlled again.

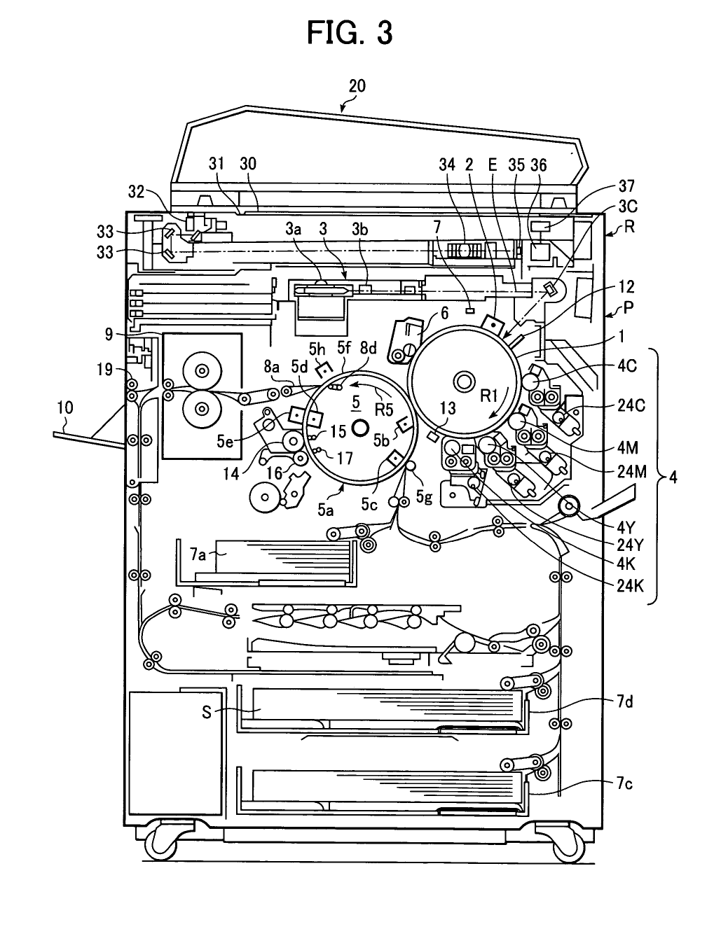

FIG. 4 is a printing operation flowchart implemented by the CPU 2001 of the controller unit 2000 in accordance with an embodiment of the present invention. First, in step 401, a user issues a print command, and the controller unit receives the job. The interpreter unit queries the job controller as to an output media type for printing the relevant page. Then, in step S402, the amount of toner application for the media type determined in step S401 is determined according to maximum toner application amount information for each media type, stored in the controller unit 2000. Alternatively, a user may specify a default maximum amount of toner application via the UI 2012. The maximum amount of toner application for each media type is predetermined for the printer engine, e.g., 180% in the case of recycled paper and 210% for normal paper. The amount of toner application of C at the maximum density level is 100%, and the maximum amounts of toner application of M, Y, and Bk at the maximum density levels is 100% each, i.e., the four colors total to 400%. Actually, however, the maximum amount of toner application is determined as described above depending on printer performance and media type.

Then, in step 403, color processing according to the respective amounts of toner application is executed in the CMS unit or the TR units in the RIP unit. The color processing in the CMS unit is based on optimum profiles of the amounts of toner application.

After completion of processing in the RIP unit (PDL processing), when a rendered image is actually output to a printer, the job controller checks the media type again in step 404. If the media type matches, printing is executed. If the predetermined media type does not match the media type that is actually used, for example, due to the absence of paper or a paper jam, and if the actual media type has a more (or less) strict restriction of the amount of toner application than the predetermined media type, the printer image processor 2115 regulates the amount of toner application in step 405, and printing is then executed in step 406.

Second Embodiment

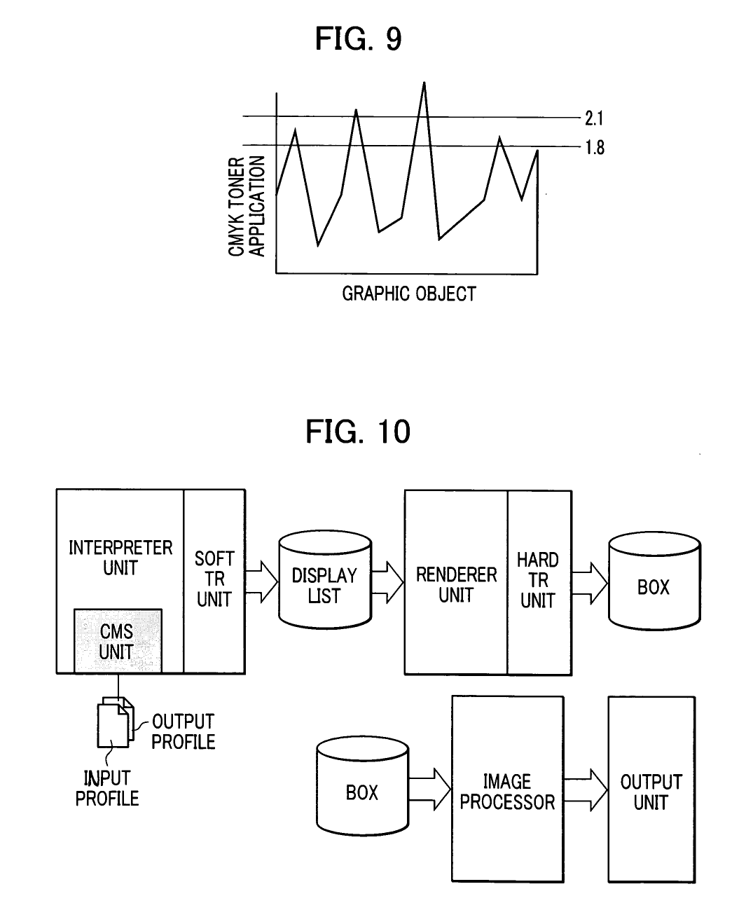

In step 501, when a job input is a box input job based on default media type information set by the user via the UI 2012, the multi-function printer 100 determines the amount of toner application suitable for the default media type. Then, in step 502, the RIP unit executes rendering according to the determined amount of toner application. In step 503, the rendered image is JPEG compressed before it is stored in the external storage device 2004 of the controller unit 2000. Information representing the amount of toner application used for rendering is also stored in the external storage device 2004 in step 503. A box input job herein refers to a job in which a rendered image is compressed by packet JPEG before the image is stored in the external storage device 2004 of the controller unit 2000. The compression method is not limited to packet JPEG, and may be other methods, e.g., JPEG 2000 or MMR (Modified Modified Read). FIG. 10 is a diagram showing control of the amount of toner application based on a media type of a box input job.

Then, in step 601, when the user issues a command to print a box input job, the job controller checks an output media type, i.e., the type of paper used for printing. Then, in step 602, a rendered image and an associated amount of toner application, stored in the external storage device 2004 of the controller unit 2000, are checked. In step 603, the job controller compares the maximum amount of toner application for the output media type with the default maximum amount of toner application stored together with the image. If the maximum amount of toner application for the output media type is less than the default maximum amount of toner application stored together with the image, the printer image processor 2115 regulates the amount of toner application in step 604, and printing is executed in step 605. On the other hand, if the maximum amount of toner application for the output media type is greater than the default maximum amount of toner application stored together with the image, printing is executed in step 605 without issuing a command relating to the maximum amount of toner application to the printer image processor 2115. As described above, if the output media type differs from the default media type, for example, due to the absence of sheets or a paper jam, and if the default amount of toner application is less than that for the predetermined media type, the printer image processor 2115 regulates the amount of toner application, and printing is then executed in step 605.

Third Embodiment

In the first embodiment, when step 404 evaluates to No, the procedure proceeds to step 405, in which the printer image processor 2115 regulates the amount of toner application. In a third embodiment of the present invention, when step 404 evaluates to No, the job controller inputs a rendered image to the interpreter unit, switches the profile used in the CMS unit to a profile in consideration of the maximum amount of toner application for the media type of recording paper, and executes color matching for the rendered image, thereby adjusting the amount of toner application. Similarly, in the second embodiment, when step 603 evaluates to No, the printer image processor 2115 regulates the amount of toner application in step 604. In the third embodiment, when step 603 evaluates to No, the job controller inputs a rendered image to the interpreter unit, switches the profile used in the CMS unit to a profile in consideration of the maximum amount of toner application for the media type of recording paper, and executes color matching for the rendered image, thereby adjusting the amount of toner application. As previously described, the adjustment of the amount of toner application by the CMS unit in the RIP unit improves image quality. However, since color matching is executed again before rendering, a longer time is required before output to the output unit compared with a case where the amount of toner application is controlled by the printer image processor 2115.

Fourth Embodiment

In the first embodiment, when step 404 evaluates to No, the procedure proceeds to step 405, in which the printer image processor 2115 regulates the amount of toner application. In a fourth embodiment of the present invention, the job controller inputs a rendered image again to the hard TR unit in the renderer unit, and the hard TR unit adjusts the amount of toner application. Similarly, in the second embodiment, when step 603 evaluates to No, the printer image processor 2115 regulates the amount of toner application in step 604. In the third embodiment, the job controller inputs a rendered image again to the hard TR unit of the renderer unit, and the hard TR unit adjusts the amount of toner application. As previously described, the TR unit only cuts the amount of toner of each color that exceeds a predetermined amount of toner application. Since the predetermined amount of toner application is rarely exceeded in ordinary images, image quality does not degrade substantially, so that image quality is higher compared with a case where the printer image processor 2115 controls the amount of toner application. However, image quality is lower compared with a case where color matching is executed in the CMS unit. Furthermore, the speed is faster compared with a case where color matching is executed again in the CMS unit. However, since re-rendering is needed, the speed is lower than a case where the printer image processor 2115 controls the amount of toner application.

Fifth Embodiment

In the first embodiment, when step 404 evaluates to No, the procedure proceeds to step 405, in which the printer image processor 2115 regulates the amount of toner application. In a fifth embodiment of the present invention, a display list is held in the RAM 2002 or the external storage device 2004 until completion of rendering. When step 404 evaluates to No, a display list corresponding to a rendered image is re-rendered, and the hard TR unit in the renderer unit adjusts the amount of toner application. The image quality and speed are similar to those of the fourth embodiment.

Sixth Embodiment

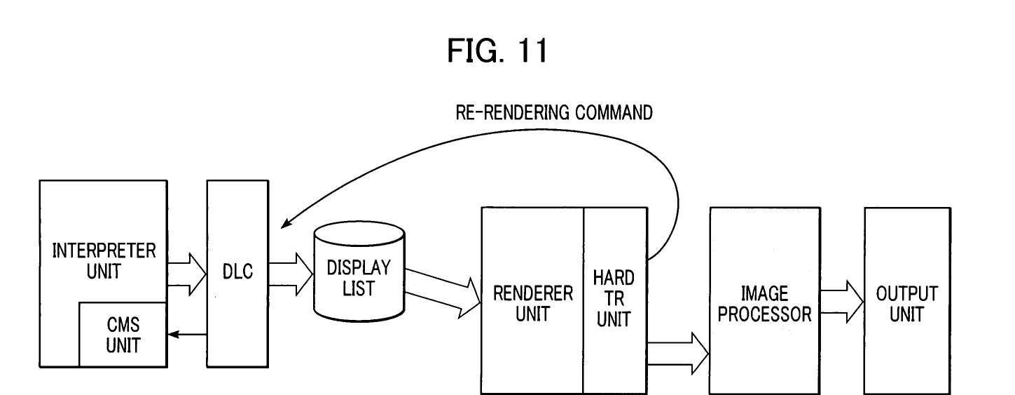

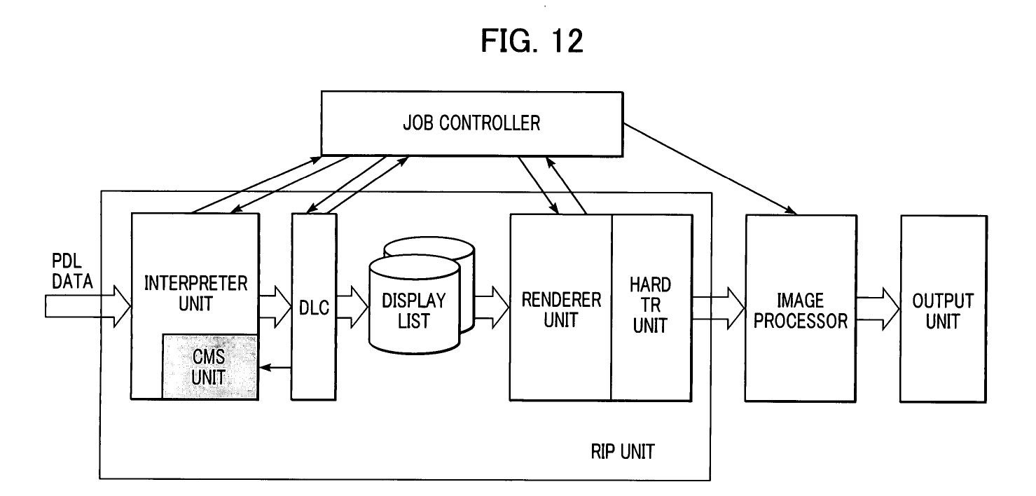

Next, regulation of the amount of toner application by the a display list control (DLC) unit is described with reference to FIG. 11, and the configuration is described with reference to FIG. 12. The DLC unit is a processor that manages a plurality of display lists. The DLC unit is allowed to call the CMS unit in the interpreter unit. It is possible, for example, to combine a display list of one page and a display list of another page, or to use different CMSs for the same display list and output results to different engines.

In the first embodiment, when step S404 evaluates to No, the procedure proceeds to step 405, in which the printer image processor 2115 regulates the amount of toner application. In a sixth embodiment of the present invention, the job controller issues a re-rendering command to the DLC unit. The DLC unit calls the CMS unit, and the CMS unit again controls the amount of toner application for the display list held in the RAM 2002 (or the external storage device 2004) using a profile in consideration of the maximum amount of toner application for the output media type.

In the second embodiment, when step 603 evaluates to No, the printer image processor 2115 regulates the amount of toner application in step 604. In the sixth embodiment, the job controller issues a re-rendering command to the DLC unit. The DLC unit calls the CMS unit, and the CMS unit again regulates the amount of toner application for the display list held in the RAM 2002 (or the external storage device 2004) using a profile in consideration of the maximum amount of toner application for the output media type.

Seventh Embodiment

In the embodiments described above, the user turns on CMS processing. A seventh embodiment of the present invention relates to processing for regulating the amount of toner application in cases where the user turns off CMS processing or a profile is created by the user.

When the user has turned off CMS processing, CMS processing in the interpreter unit is disabled. Thus, the TR unit regulates the amount of toner. When a need for changing the amount of toner application arises due to, for example, change in the output media type due to the absence of paper, the image processor or the TR unit controls the amount of toner application. When a profile created by the user is used, although CMS processing is enabled, it is not certain whether the profile is created in consideration of the regulation of the amount of toner application. Thus, it is not ensured that color management is executed so that the maximum amount of toner application, determined by the media used and printer engine used, is satisfied. Thus, it is determined whether signal level after CMS processing (i.e., color matching) is in accordance with the maximum amount of toner application, determined by the media and printer engine used. When the amount of toner application must be changed, the TR unit or the image processor regulates the amount of toner application as needed, and outputs the result. The same applies to the case of a box input job.

Eighth Embodiment

In the embodiments described above, the amount of toner application is determined for each media type. Alternatively, the amount of toner application may be determined on the basis of environmental conditions detected, such as temperature and humidity. It is assumed that the amount of toner application associated with an environmental condition is predetermined. More specifically, output media types, combinations of temperature and humidity, and maximum amounts of toner application are stored in a look-up table (LUT) in the RAM 2002. Furthermore, although the embodiments have been described in the context of PDL printing, the present invention can also be applied to copying jobs. Furthermore, although toner is used as a coloring material in the embodiments described above, alternatively, ink may be used. Furthermore, although the amount of toner application is changed depending on the media type in the embodiments described above, the amount of toner application may be changed depending on the media size. Furthermore, although the embodiments have been described in the context of an MFP, the present invention can also be applied, for example, to an ink jet printer in which the amount of toner application is regulated. Furthermore, the present invention can also be applied to copying machines, laser beam printers, and the like.

As described above, after controlling the amount of toner application for each media type in the RIP unit, if the predetermined media type does not match the output media type, the amount of toner application is adjusted again. Accordingly, the engine is protected, and the amount of coloring material in recording material is controlled appropriately. Furthermore, in a printer in which the amount of toner application is predetermined by the engine, even in the case of a box input job, the amount of toner application is adjusted by the image processor or the RIP unit, so that the engine is protected and image quality is improved.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. An image processing apparatus comprising:
first determining means for determining a first medium on which an image is to be formed;
second determining means for determining an amount of a coloring material of a recording material corresponding to the first medium;
color processing means for executing color processing based on the amount of the coloring material determined to correspond to the first medium;
third determining means for determining a second medium on which the image is actually output;
comparing means for comparing the first and the second medium to determine whether these media match; and
controlling means for controlling whether to adjust the amount of the coloring material again according to a result of the comparison by the comparing means.

2. An image processing apparatus comprising:
determining means for determining an amount of a coloring material of a recording material according to an environmental condition detected;
color processing means for executing color processing in a raster image processing unit according to the amount of the coloring material determined by the determining means;
comparing means for comparing a predetermined medium with a medium that is to be used for output to determine whether these media match, after the color processing by the color processing means; and
controlling means for controlling whether to adjust the amount of the coloring material again according to a result of the comparison by the comparing means.

3. The image processing apparatus according to claim 1, wherein when it is determined that the amount of the coloring material is to be adjusted again, the amount of the coloring material is adjusted in an image processing unit of a printer.

4. The image processing apparatus according to claim 1, wherein when it is determined that the amount of the coloring material is to be adjusted again, the amount of the coloring material is adjusted again in raster image processing unit.

5. The image processing apparatus according to claim 1, wherein when it is determined that the amount of the coloring material is to be adjusted again, an image obtained by the color processing is again input to a renderer unit, and the amount of the coloring material is adjusted in the renderer unit.

6. The image processing apparatus according to claim 1, wherein when it is determined that the amount of the coloring material is to be adjusted again, a display list is re-rendered, and the amount of the coloring material is adjusted in a toner reduction unit.

7. The image processing apparatus according to claim 1, wherein when it is determined that the amount of the coloring material is to be adjusted again, the amount of the coloring material is adjusted again in a color management apparatus unit.

8. An image processing apparatus comprising:
determining means for allowing a user to determine an amount of a coloring material of a recording material;
color processing means for executing color processing in a raster image processing unit for a job stored on a storage medium, according to the amount of the coloring material determined by the determining means;
maintaining means for maintaining an image rendered by the color processing means and an amount of the coloring material used for rendering;
comparing means for comparing the amount of the coloring material maintained by the maintaining means with an amount of the coloring material for a medium that is to be used for output; and
adjusting means for adjusting the amount of the coloring material maintained by the maintaining means to the amount of the coloring material for the medium that is to be used for output when these amounts do not match according to the comparison by the comparing means.

9. The image processing apparatus according to claim 8, wherein the adjusting means adjusts the amount of the coloring material in the raster image processing unit or in an image processing unit.

10. The image processing apparatus according to claim 8, wherein the adjusting means adjusts the amount of the coloring material in a color management apparatus unit in the raster image processing unit.

11. The image processing apparatus according to claim 8, wherein the adjusting means adjusts the amount of the coloring material in a toner reduction unit of the raster image processing unit by inputting the rendered image to a renderer unit.

12. The image processing apparatus according to claim 8, wherein the adjusting means adjusts the amount of the coloring material in a color management apparatus unit of the raster image processing unit, the color management apparatus unit being controlled by a display list control unit.

13. The image processing apparatus according to claim 8, wherein the amount of the coloring material determined by the determining means is a maximum amount of the coloring material for a medium that is to be for output.

14. An image processing method comprising:
a first determining step of determining which medium an image is to be formed on;
a second determining step of determining an amount of a coloring material of a recording material according to the medium determined in the first determining step;
a color processing step of executing color processing in a raster image processing unit according to the amount of the coloring material determined in the second determining step;
a comparing step of comparing a predetermined medium with a medium to be used for output to determine whether these media match; and
a controlling step of controlling whether to adjust the amount of the coloring material again according to a result of the comparison in the comparing step.

15. An image processing method comprising:
a determining step of determining an amount of a coloring material of a recording material according to an environmental condition detected;
a color processing step of executing color processing in a raster image processing unit according to the amount of the coloring material determined in the determining step;
a comparing step of comparing a predetermined medium with a medium to be used for output to determine whether these media match; and
a controlling step of controlling whether to adjust the amount of the coloring material again according to a result of the comparison in the comparing step.

16. The image processing method according to claim 14, wherein when it is determined that the amount of the coloring material is to be adjusted again, the amount of the coloring material is adjusted in an image processing unit for a printer.

17. The image processing method according to claim 14, wherein when it is determined that the amount of the coloring material is to be adjusted again, the amount of the coloring material is adjusted in the raster image processing unit.

18. An image processing method comprising:
a determining step of allowing a user to determine an amount of a coloring material of a recording material;
a color processing step of executing color processing in a raster image processing unit for a job that is stored on a storage medium according to the amount of the coloring material determined in the determining step;
a maintaining step of maintaining an image rendered in the color processing step and an amount of the coloring material used for rendering;
a comparing step of comparing the amount of the coloring material maintained in the maintaining step with an amount of the coloring material for a medium that is to be used for output; and
an adjusting step of adjusting the amount of the coloring material maintained in the maintaining step to the amount of the coloring material for the medium that is to be used for output when these amounts do not match according to the comparison in the comparing step.

19. The image processing method according to claim 18, wherein the amount of the coloring material is adjusted in the adjusting step in the raster image processing unit or in an image processing unit.

20. A program for allowing a computer to execute the steps of the image processing method according to claim 14.

21. A program for allowing a computer to execute the steps of the image processing method according to claim 15.

22. A program for allowing a computer to execute the steps of the image processing method according to claim 18.

23. The apparatus of claim 7 further comprising a display list control means for controlling the color management apparatus.

24. An image processing method comprising:
determining a first medium on which an image is to be formed;
determining an amount of a coloring material suitable for recording the image on the first medium;
using a raster image processing unit to process the image based on the amount of the coloring material determined to be suitable for the first medium;
determining a second medium on which the image is actually output;
comparing the first and the second medium to determine whether these media match; and
adjusting the amount of the coloring material on the second medium if the first and the second medium do not match.

25. The method of claim 24 wherein the amount of material suitable for recording the image is determined by a user.
